(19) United States
(12) Patent Application Publication
(10) Pub. No.: US 2010/0183201 A1
(43) Pub. Date: Jul. 22, 2010

(54) Adaptive Software and Hardware System for Scientific Image Processsing

(76) Inventors: Frank Johan Schwab, New York, NY (US); Virginie Lafage, New York, NY (US)

Correspondence Address: SENNIGER POWERS LLP, 100 NORTH BROADWAY, 17TH FLOOR, ST LOUIS, MO, 63102, US

(21) Appl. No.: 12/212,699

(22) Filed: Sep. 18, 2008

(51) Int. Cl. G06K 9/00; G06F 3/00; G06F 17/30; G06Q 50/00; G06Q 30/00; G06Q 20/00; G06Q 10/00

(52) U.S. Cl. 382/128; 710/13; 707/671; 705/2; 726/17

(57) ABSTRACT

A modular software and hardware scientific image analysis and processing system adaptable to a wide variety of practical tasks in various specialties of the sciences. Modules and their interconnections are selected according to the specialty needs of users, permitting intermediate storage, transmission, or transport on external storage devices. Modules are included for (a) universal image acceptance from a wide variety of formats, including most DICOM formats, an otherwise tedious task in medical practice, (b) image evaluation through a variety of science-specific measurements, simulation of changes or interventions, or simulated implants or grafts, (c) management of supply logistics, also for implants or grafts, (d) semi-automatic report generation as required, for example, in medical practice, (e) organized storage of active images, including measurements, re-measurements, and intervention strategies for easy access from various locations or possible distribution, and (f) large scale, organized image archiving possibly permitting retrieval from various locations and image sharing.

A modular image processing software system embedded in a flexible hardware system both adaptable to a wide variety of practical needs in the sciences, with the software being stand-alone, available on an external storage medium such as a USB key, consequently portable and not requiring computer installation as often negated within large institutional IP systems. The software modules offering novel measurement and simulation options for specific applications in the sciences and medicine.

The proposed system may find equally useful application in medicine as also in biology, urban planning, or other sciences requiring the analysis and processing of images. In biology, the growth or formation of plant or animal specimens may be of interest, as may be development growth and alternative traffic connections in urban planning The following presentation, for the purpose of illustration, concentrates on medical surgical applications, specifically in orthopedics, whether in the subspecialty of spine, of hip/knee, of other surgery areas. However, the system is equally applicable to other specialties and other sciences.

### CROSS REFERENCE TO RELATED APPLICATIONS. GENERAL BACKGROUND

In the modern IP environment, scientist of many specialties, from the medical professionals to biologists, and urban planners, often work with not only one, but with several computers, for example, one in the office, another in the laboratory, and the one at home. The work-related computers may be under central institutional control not permitting new software installation.

When images must be processed, they may arrive in a variety of formats, including, for example, not only the jpeg, png and bmp formats, but also the large variety of DICOM formats, specifically for medical radiographs and MRI images. This image acquisition often requires much time, presenting a time-consuming nuisance to the practitioner, even the need for costly and time consuming re-taking of images in an acceptable format. The subsequently following image processing may require a variety of specialty-specific measurements or simulations of interventions, some not commonly available for image processing. Certain surgeries require specific supplies or implants from outside manufacturers. The simulation of these surgeries as possible with the proposed system can result in advance procurement and storage of supplies or implants for future need. Professional reports on the analysis of patient conditions and treatment recommendations must be written. Finally, the most active patient images must be stored in an easily transportable and accessible manner including the added measurements or intervention simulations. In the end, an archive must be available for the less active images accumulated over longer periods of time.

This sequence of functions may be conducted in various steps on different computers, requiring the intermediate storage and possibly the transport of images or prior research results from site to site, either physically on external storage media such as USB keys or electronically. The necessary hardware modules for the above described software modules may be separate and available at different locations, requiring intermediate data storage or transport. These hardware modules may also be more or less combined in larger and more complex PCs or central processors.

Bits and pieces of the hereby offered software and hardware system may be available from various sources. However, the proposed composite system and a large variety of proposed specific solutions to the problems for each of the indicated steps are novel as indicated in this patent application.

### SPECIFIC FUNCTIONAL DESCRIPTION

The software for the proposed software and hardware system is supplied to the subscriber on an external storage medium such as a USB key or, when so desired, can be downloaded from a specific website. The external storage or key-based option makes the software system independent, self-supporting, and easily transportable. It allows usage in environments, as in large hospitals or research laboratories with central computer systems, which otherwise are not accessible to new software due to restrictions imposed by administror rights.

The activation of the first software module allows acceptance of transmitted or, in the case of medical practitioners, specifically surgeons, patient supplied images often presented on CDs in unique DICOM formats, not readable by standard PCs. The still increasing large number of such DICOM variations is addressed by periodic up-grades to the system. Similar situations with other image formats can be addressed in the same general manner. After image acquisition, the now standardized images can be kept in active memory, transmitted to the processing module, ore stored on the USB key for transport to the next module.

The second module, the processing module, often in a different location from image acceptance modules, is proposed in a wide variety of science specialty specific implementations. The specifically selected processing module allows a variety of the practitioner's specialty-specific measurements and, often more importantly, intervention simulations. Many medical professionals in the environment of medical schools, and other scientist in their environment, do not only perform the functions of medical doctors or teachers, but also participate in research in laboratory settings and on or off-site multi-center collaborative efforts. Therefore, the image processing may occur in a different location and setting from the image acquisition. The proposed system offers specific innovative processing functions on a variety of processing modules for some scientific and medical specialties while others are still being developed and will be added by means of up-grades. For example, among the specialty processing functions for spine surgeons are simulations of osteotomies and other resections of bone or soft tissues.

Planned and simulated medical interventions can result in variations to locations and, consequently, measurements based upon landmarks or portions of antomic structures. The proposed system allows the recalculation of various measurements performed on original imaging studies to reflect the expected impact of such simulated interventions. After image processing, the images containing the measurement and simulated intervention entries can be kept in a limited capacity active memory, transmitted to the reporting module, ore stored on the USB key for transport to the next module.

The third module, for the management of supply logistics, is also offered in a variety of application-specific implementations. Such a module may contain an inventory or catalogue of virtual objects, supplies and implants offered by preferred outside vendors or stored by the practitioner's institution. Selected items may be virtually moved into patient's images and implantation may be simulated. This can lead to the selection of desired supplies and implants needed for a specific planned intervention and their electronic ordering and even their payment. Such electronic connection of intervention planning and supply logistics provides considerable improvement, reducing valuable time and costs to user, customer and supplier alike.

The fourth module, the report generation module, is also proposed in a variety of application-specific implementations. Such a module provides ease of summary files or documents based on identification indicators often contained in the basic image information, specifically in DICOM-based images and can combine this with image files, measurements by the user and simulated intervention. The reports can be prepared assisted by a menu of preprogrammed routine report comments, on values resulting from the processing modules, on individually provided information, and on the selection of recipient addresses or report storage locations from a given list. This report function can be programmed to generate reports in pre-established formats on standard forms. After report generation, the images with the measurement and simulated intervention entries and attached report, can be kept in active memory, transmitted to the active storage module or be kept, for example, on the USB key, for transport to the next module or for sharing with other practitioners or researchers.

The fifth module, the active storage module may preferably be a USB key for easy transport and data independence from central systems. This may be the same key which contains the original software system. It may also be a different key, a CD writer, or storage on the practitioner's computer or a central computer. The proposed software system allows for installation of an organized active image storage for ease of quick retrieval from various locations or for sharing with other practitioners. The images may also be transferred to the archiving module.

The archiving module, providing voluminous storage capacity for possibly years of images acquired and analyzed, is foreseen as being external, accessible through online connection possibly provided by one of the very large industrial data storage companies, but organized and under the control of the user of the proposed system.

### SUMMARY OF THE INVENTION, OBJECTS

It is the object of this invention to render the work of the researcher or medical practitioner more efficient, specifically when working with images, for example in surgery, biology, and many other areas, by saving time and resources, and permitting optimal results. Such time saving and result improvement may be important in competitive settings, but even more important for the benefit of medical patients.

What is claimed is:

1. A computer software system combined with a hardware system for scientific image processing being able to be of stand-alone application such as one that would be on an external storage medium such as a USB key, and consisting of various adaptively selectable software and hardware modules with intermediate internal storage or separate transportable storage or transmission capability as needed, comprising:
a. A software and hardware module for image acceptance in practically all formats, including a large variety of DICOM formats, periodically upgraded to include newly appearing formats
b. A software and hardware module for executing specialized measurements and simulated interventions,
c. A software and hardware module for supply logistics control,
d. A software and hardware module for report generation,
e. A software and hardware module for intermediate storage, and
f. A software and hardware module for archiving files containing image related information.
g. All indicated modules provided with intermediate internal storage or separate transportable storage, as on USB keys, or having online transmission capability.

2. A system according to claim 1, wherein its software is stored and run from an external medium such as a USB key, thereby not requiring program installation on, for example, an institutional computer where installation and usage rights may be restricted

3. A system according to claim 1, wherein the activation of the first module, the image acceptance module, allows acceptance of transmitted or, in the case of medical practitioners, specifically in the case of surgeons, patient supplied images often presented as CDs in unique DICOM formats, not readable by standard PCs. The still increasing large number of such DICOM variations is addressed by periodic up-grades to the system. After image acquisition, the now standardized images can be kept in active memory, transmitted to the processing module, or stored on an external storage medium such as a USB key for transport and later utilization in another module.

4. A system according to claim 1, wherein the second module, the processing module, often in a different location from image acceptance modules, allows specific measurement and, often more importantly, intervention simulations. The image processing may occur in a different location and setting from the image acquisition. The proposed system offers specific innovative processing functions for scientific and medical specialties. Among the specialty processing functions for spine surgeons are simulations of implantation of devices, osteotomies and other resections of bone or soft tissues. Planned and simulated medical interventions can result in variations in the relative locations of anatomic structures and, consequently, measurements applied by the user. The proposed system allows the recalculation of various measurements performed on original imaging studies to reflect the impact of simulated interventions. After image processing, the images with the measurement and simulated intervention entries can be kept in active memory, transmitted to the reporting module, or stored by external medium such as USB key for transport to the next module.

5. A system according to claim 1, wherein the third module, for the management of supply logistics, may contain an inventory or catalogue of supplies and implants offered by outside vendors or stored by the practitioner's institution. Selected items may be moved into patient's images and implants simulated. This can lead to the selection of all those supplies which are needed for a planned intervention and their electronic ordering and even their payment.

6. A system according to claim 1, wherein The fourth module, the report generation module, often in a different location from the image processing and supply logistics modules, provides ease of report generation based on metadata or identification indicators often contained in the basic image information, specifically in DICOM-based images. The reports can be prepared assisted by a menu of preprogrammed routine report comments, on values resulting from the processing modules, on individually provided information, and on the selection of recipient addresses or report storage locations from a given list. This report function can be programmed to generate reports in pre-established formats on standard forms. After report generation, the images with the measurement and simulated intervention entries, attached report, and logistics information can be kept in active memory, transmitted to the active storage module or be kept, on an external storage medium such as a USB key, for transport to the next module or for sharing with other practitioners or researchers.

7. A system according to claim 1, wherein the fifth module, the active storage module, may preferably be located on an external storage medium such as a USB key for easy transport and data independence from central institutional systems. This may be the same key which contains the original software system. It may also be a different key, a CD writer, or storage on a computer. The proposed software system allows for file storage for ease of quick retrieval from various computer locations or for sharing with other practitioners. The images may also be transferred to the archiving module.

8. A system according to claim 1, wherein the sixth module, the archiving module, providing voluminous storage capacity for possibly years of images acquired and analyzed, is foreseen as being external, but organized and under the control of the user of the proposed system.

9. A system according to claim 1, wherein all indicated modules are provided with intermediate internal storage or separate transportable storage, as on devices such as external drives or USB keys, or permit online transmission.
